(19) United States
(12) Patent Application Publication
(10) Pub. No.: US 2026/0196706 A1
(43) Pub. Date: Jul. 9, 2026

(54) DUAL-BAND CIRCULARLY POLARIZED ANTENNA INTEGRATED WITH THERMAL PROTECTION SYSTEM AND DESIGN METHOD FOR ARTIFICIAL REFLECTING SURFACE

(71) Applicant: Beihang University, Beijing (CN)

(72) Inventors: Qi WU, Beijing (CN); Haoqing WEN, Beijing (CN)

(73) Assignee: Beihang University, Beijing (CN)

(21) Appl. No.: 19/370,849

(22) Filed: Oct. 28, 2025

(30) Foreign Application Priority Data
Jan. 8, 2025 (CN) 202510027772.2

(51) Int. Cl. H01Q 1/00; H01Q 5/20; H01Q 15/24

(52) U.S. Cl. CPC H01Q 1/002; H01Q 5/20; H01Q 15/24

(57) ABSTRACT

A dual-band circularly polarized antenna integrated with a thermal protection system includes a thermal protection system and an artificial reflecting surface. The thermal protection system is a planar double-layer thermal protection sheet and covers the dual-band circularly polarized antenna to isolate the antenna from an external heat source. The artificial reflecting surface is positioned beneath an antenna substrate to replace a ground plane of the antenna, spaced apart from the antenna by a specific distance and configured to restore the circular polarization performance of the antenna degraded in the presence of the thermal protection system and the ground plane. By replacing the ground plane of the antenna with the artificial reflecting surface, the performance of the circularly polarized antenna may be effectively improved without altering the thermal protection system, and the overall electric performance and thermal protection performance of the system are well balanced.

### CROSS REFERENCE TO THE RELATED APPLICATIONS

This application is based upon and claims priority to Chinese Patent Application No. 202510027772.2, filed on Jan. 8, 2025, the entire contents of which are incorporated herein by reference.

### TECHNICAL FIELD

The invention relates to the field of dual-band circularly polarized antennas, in particular to a dual-band circularly polarized antenna integrated with a thermal protection system and a design method for an artificial reflecting surface.

### BACKGROUND

In recent years, hypersonic vehicles have attracted significant attention worldwide due to their long range, high speed, and high precision. The antenna, as a front-end component of an electronic communication system on a flight vehicle, serves as a key device for converting electromagnetic energy between the flight vehicle and other electronic systems. It plays a critical role in ensuring effective communication of the flight vehicle. For hypersonic operations, the antenna must not only exhibit good electrical performance but also withstand the extreme high-temperature environment. To meet these requirements, the antenna is typically shielded by a thermal protection system. Since the thermal protection system is thick and lossy, it will degrade the radiation performance of the antenna by reducing the bandwidth, diminishing the resonant depth, and worsening the axial ratio of circularly polarized antennas, compromising the overall communication effectiveness.

At present, there is a lack of research on restoring the performance of antennas embedded within thermal protection systems, often requiring extensive design iterations and simulations. Existing design processes remain largely empirical, relying on engineering experience, and lack a systematic theoretical framework.

### SUMMARY

The objective of the invention is to overcome the defects in the prior art by providing a dual-band circularly polarized antenna integrated with a thermal protection system, and a design method for an artificial reflecting surface, which may restore the performance of a circularly polarized antenna degraded by the presence of a thick and lossy thermal protection system, thereby significantly enhancing the performance of the antenna.

To fulfill the above objective, the invention adopts the following technical solution: In a first aspect, the invention provides a dual-band circularly polarized antenna integrated with a thermal protection system, including:
a thermal protection system 1 and an artificial reflecting surface 7, wherein the thermal protection system 1 is a planar double-layer thermal protection sheet and covers the dual-band circularly polarized antenna 2 to isolate the antenna from an external heat source. The artificial reflecting surface 7 is positioned beneath an antenna substrate to replace a ground plane of the antenna, spaced apart from the antenna by a specific distance and configured to restore circular polarization performance of the antenna degraded by the presence of the thermal protection system and the ground plane.

Further, an outer layer of the double-layer thermal protection sheet is an ablative layer and has a dielectric constant of 2-9, and an inner layer of the double-layer thermal protection sheet is a thermal insulation layer and has a dielectric constant of 1.2-9.

Further, the outer layer of the double-layer thermal protection sheet has a thickness of 8-12 mm, and the inner layer of the double-layer thermal protection sheet has a thickness of 6-15 mm.

Further, the dual-band circularly polarized antenna is a printed antenna with a profile less than a set value.

Further, the outer layer 5 of the double-layer thermal protection sheet is made from a fiber-enhanced silica composite material and has a dielectric constant of 3.2, and the inner layer 6 of the double-layer thermal protection sheet is made from a fiber-enhanced silica aerogel composite material and has a dielectric constant of 1.2.

Further, the artificial reflecting surface 7 is formed by a dielectric substrate 3 and surface metallic patches 4.

Further, the dielectric substrate 3 is made from a material with a dielectric constant of 1.2-9 and has a thickness of 0.25-2 mm.

In a second aspect, the invention provides a design method for an artificial reflecting surface, including:
S1, calculating an equivalent network for widening an axial ratio beamwidth of an ideal circularly polarized antenna, wherein the equivalent network is formed by lossless inductor-capacitor elements and transmission lines;
S2, designing corresponding unit cells according to the obtained equivalent network, wherein the inductor-capacitor elements are fitted by surface metallic patches, the transmission lines are fitted by a dielectric substrate; and
S3, periodically arranging the unit cells to obtain an artificial reflecting surface.

The invention has the following beneficial effects:

By replacing the ground plane of the antenna with the artificial reflecting surface, the performance of the circularly polarized antenna degraded by the presence of the thick and lossy thermal protection system may be restored, for example, the resonant frequency may be recovered, the resonant depth may be restored, the axial ratio bandwidth may be increased, and the axial ratio beamwidth may be widened. The overall electrical performance and thermal protection performance of the system are well balanced without altering the structure of the thermal protection system.

### BRIEF DESCRIPTION OF THE DRAWINGS

FIG. 1 is a schematic diagram of the arrangement relationship of an antenna and a thermal protection system according to an embodiment of the invention.

FIG. 2 is a schematic structural diagram of an artificial reflecting surface according to an embodiment of the invention.

FIG. 3 is a schematic diagram of unit structures of the artificial reflecting surface shown in FIG. 2 according to an embodiment of the invention.

FIG. 4 is a schematic diagram of an outer layer and an inner layer of the thermal protection system and the artificial reflecting surface according to an embodiment of the invention.

FIG. 5 is a schematic diagram of structural parameters of a dual-electric dipole and dual-band circularly polarized antenna according to an embodiment of the invention.

FIG. 6 illustrates the influence of the thermal protection system and a metallic ground on the reflection coefficient of the dual-band circularly polarized antenna according to an embodiment of the invention.

FIG. 7 illustrates the influence of the thermal protection system and the metallic ground on the axial ratio of the dual-band circularly polarized antenna according to an embodiment of the invention.

FIG. 8 illustrates the reflection coefficient of the dual-band circularly polarized antenna loaded with the thermal protection system in a case where the artificial reflecting surface is used to replace the metallic ground according to an embodiment of the invention.

FIG. 9 illustrates the axial ratio of the dual-band circularly polarized antenna loaded with the thermal protection system in a case where the artificial reflecting surface is used to replace the metallic ground according to an embodiment of the invention.

FIG. 10 illustrates the axial ratio beamwidth of the dual-band circularly polarized antenna loaded with the thermal protection system in a case where the artificial reflecting surface is used to replace the metallic ground according to an embodiment of the invention.

FIG. 11 illustrates the circular polarization gain of the dual-band circularly polarized antenna loaded with the thermal protection system in a case where the artificial reflecting surface is used to replace the metallic ground according to an embodiment of the invention.

In the figures: 1, thermal protection system; 2, dual-band circularly polarized antenna; 3, dielectric substrate; 4, metallic patch; 5, outer layer of double-layer thermal protection sheet; 6, inner layer of double-layer thermal protection sheet; 7, artificial reflecting surface.

### DETAILED DESCRIPTION OF THE EMBODIMENTS

To clearly present the objectives, technical solutions, and advantages of the invention, the technical solutions of the embodiments are described in detail below with reference to the accompanying drawings.

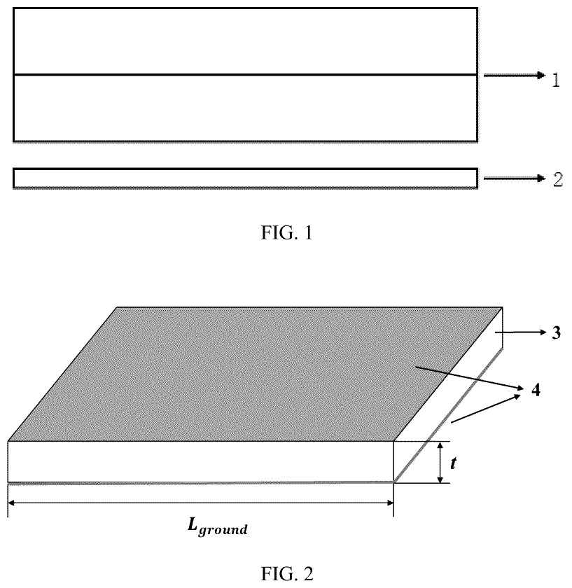

The invention is described in detail below in conjunction with FIGS. 1-11.

The invention provides a dual-band circularly polarized antenna integrated with a thermal protection system. As shown in FIG. 1, the dual-band circularly polarized antenna includes a thermal protection system 1 and an artificial reflecting surface 7. The thermal protection system 1 is a planar double-layer thermal protection sheet and covers the dual-band circularly polarized antenna 2 to isolate the antenna from an external heat source. The artificial reflecting surface 7 is positioned beneath an antenna substrate to replace a ground plane of the antenna, spaced apart from the antenna by a specific distance and configured to restore the circular polarization performance of the antenna degraded by the presence of the thermal protection system and the ground plane, including reductions in the −10 dB bandwidth, shifts in the resonant frequency band and deterioration of the axial ratio.

The planar double-layer thermal protection sheet is loaded at the top of the antenna and isolates the antenna from the external heat source. An outer layer 5 of the planar double-layer thermal protection sheet is an ablative layer and has a dielectric constant of 2-9. An inner layer 6 of the planar double-layer thermal protection sheet is a thermal insulation layer and has a dielectric constant of 1.2-9. The outer layer of the planar double-layer thermal protection sheet has a thickness of 8-12 mm, and the inner layer of the planar double-layer thermal protection sheet has a thickness of 6-15 mm.

The antenna provided by the invention is a dual-band circularly polarized antenna, and to be specific, it is a dual-electric dipole patch antenna, including dual-electric dipole radiators and a dielectric substrate. The dual-electric dipole radiators are printed on front and back sides of the dielectric substrate. The substrate has a dielectric constant of 1.2-9 and a thickness of 0.25-2 mm. The antenna provided by the invention is positioned beneath the thermal protection system and shielded by the thermal protection system, thereby being isolated from a heat source.

The invention further provides a design method for an artificial reflecting surface, including:
S1, an optimal equivalent network for widening the axial ratio beamwidth of an ideal circularly polarized antenna is calculated, wherein the equivalent network is formed by lossless inductor-capacitor elements and transmission lines.
S2, corresponding unit cells are designed according to the optimal equivalent network obtained in S1, wherein the inductor-capacitor elements are fitted by surface metallic patches, and the transmission lines are fitted by a dielectric substrate.
S3, the unit cells are arranged periodically to form an infinite artificial reflecting surface.
S4, the artificial reflecting surface is arranged beneath an antenna and spaced apart from the antenna by a specific distance.

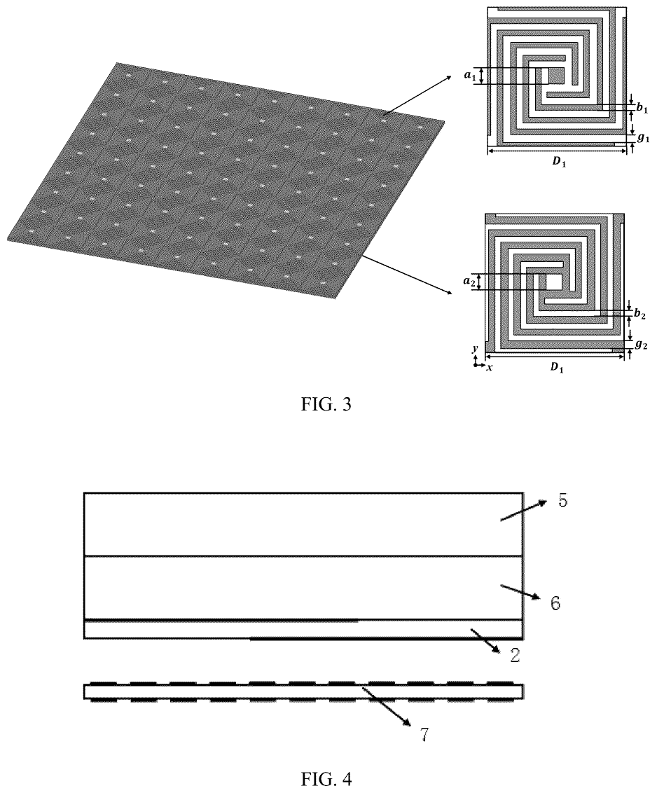

The artificial reflecting surface designed based on the design method, as shown in FIGS. 2 and 3, is formed by the dielectric substrate and the surface metallic patches. The artificial reflecting surface is positioned beneath an antenna substrate to replace a ground plane of the antenna and separated from the antenna by a specific distance. The dielectric substrate is made from a material with a dielectric constant of 1.2-9 and has a thickness of 2-5 mm.

By replacing the ground plane of the antenna with the artificial reflecting surface, the performance of the embedded circularly polarized antenna degraded by the presence of the thick and lossy thermal protection system may be effectively restored. For instance, the resonant frequency may be recovered, the resonant depth may be restored, the axial ratio bandwidth may be increased, and the axial ratio beamwidth may be widened. The overall electrical performance and thermal protection performance of the system are well balanced without altering the structure of the thermal protection system.

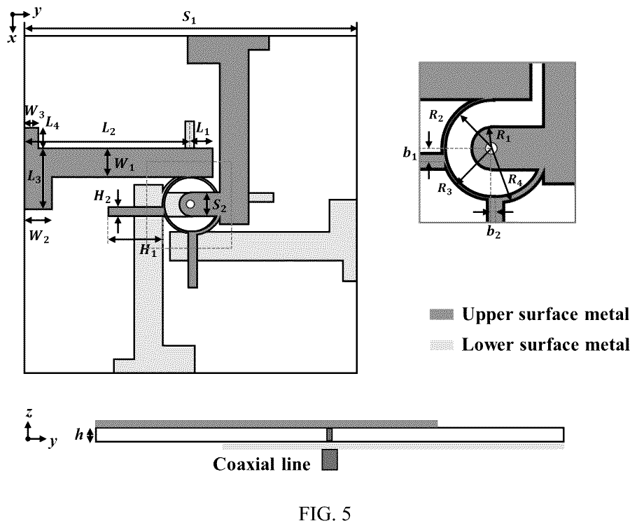

As shown in FIG. 4, in this embodiment, the outer layer of the dual-layer thermal protection system is made from a fiber-enhanced silica composite material and has a dielectric constant of 3.2, a loss tangent of 0.008 and a thickness of 8 mm; and the inner layer of the dual-layer thermal protection system is made from a fiber-enhanced silica aerogel composite material and has a dielectric constant of 1.2, a loss tangent of 0.004 and a thickness of 12 mm. A reference antenna is a dual-electric dipole printed antenna having the characteristic of dual-band circular polarization. As shown in FIG. 5, related parameters of the antenna are illustratively set as follows: S₁=38 mm, h=1.524 mm, S₂=2.76 mm, L₁=2.4 mm, L₂=19 mm, L₃=7 mm, L₄=2 mm, W₁=3.4 mm, W₂=3 mm, W₃=1.5 mm, H₁=6.2 mm, H₂=1 mm, R₁=1.38 mm, R₂=3.1 mm, R₃=3.4 mm, R₄=3.7 mm, b₁=0.8 mm, b₂=0.1 mm. The antenna substrate is made from RO4003 and has a dielectric constant of 3.55, a loss tangent of 0.0027, and a thickness of 1.524 mm.

The artificial reflecting surface includes: the dielectric substrate and the surface metallic patches. As shown in FIG. 2, the artificial reflecting surface is positioned beneath the antenna substrate to replace the ground plane of the antenna and separated from the antenna by a distance Hₐᵢᵣ=8.9mm. Related parameters of the artificial reflecting surface are illustratively set as follows: a₁=a₂=0.76 mm, b₁=0.4 mm, b₂=0.1 mm, g₁=0.1 mm, g₂=0.4 mm, D₁=5.66 mm, as shown in FIG. 3.

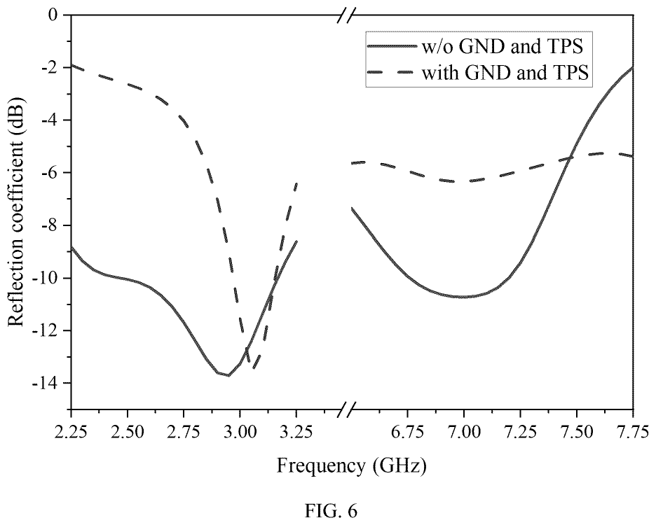

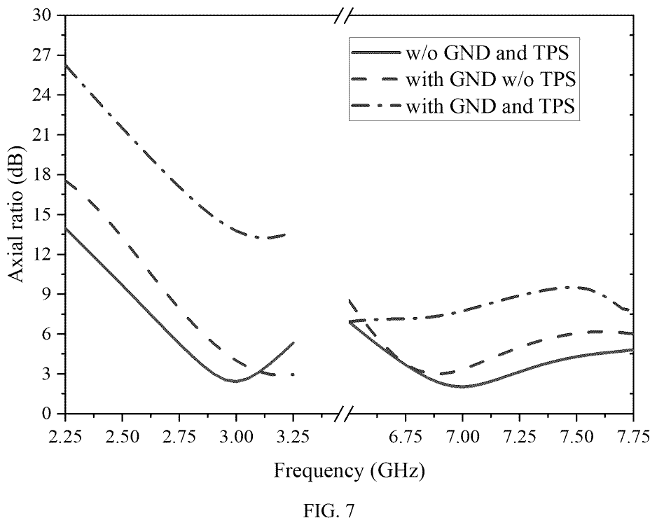

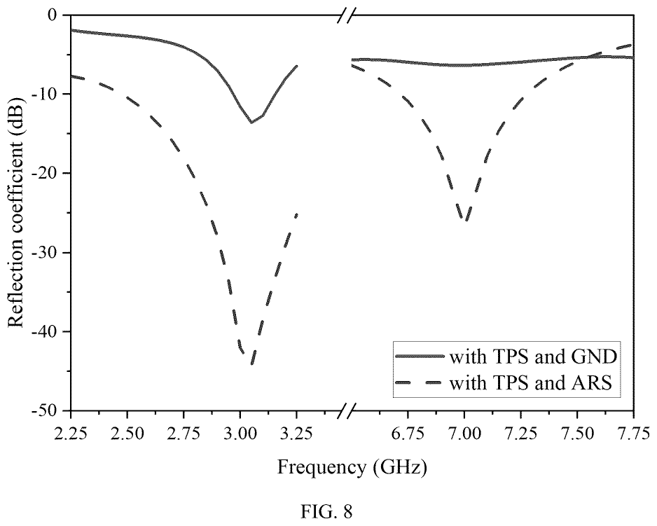

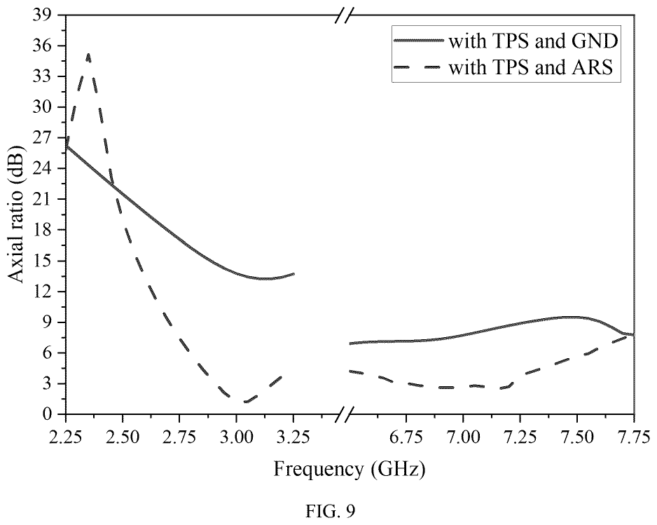

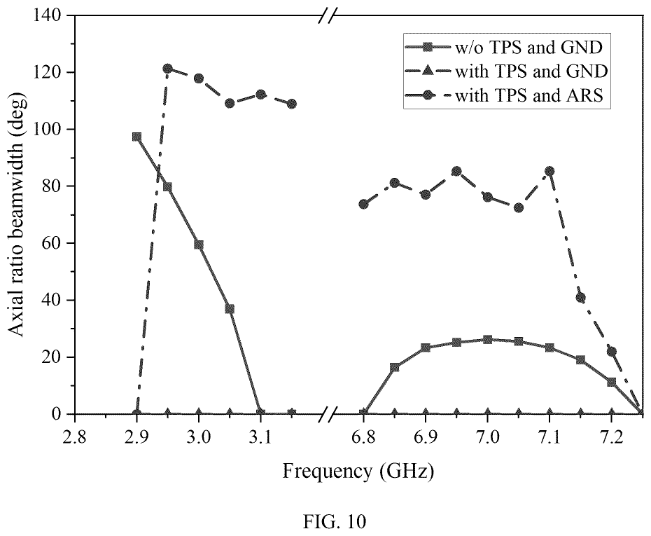

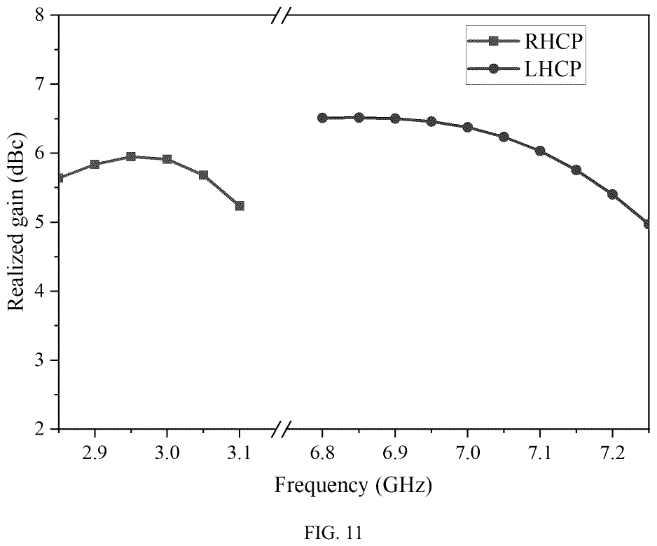

The presence of the thermal protection system will compromise the circular polarization performance of the embedded antenna, which is especially manifested by reductions in the −10 dB bandwidth, shifts in the resonant frequency, and deterioration of the axial ratio, as shown in FIGS. 6 and 7. By replacing the ground plane of the antenna with the artificial reflecting surface, the shifts in the resonant frequency are avoided, the resonant depth is restored, and as shown in FIG. 8, the low-frequency bandwidth of the antenna is widened to 2.48-3.6 GHz, and the high-frequency bandwidth of the antenna is widened to 6.7-7.3 GHz. The 3 dB axial ratio bandwidth of the antenna is restored, and as shown in FIG. 9, the low-frequency 3 dB axial ratio bandwidth is widened to 2.91-3.16 GHz, and the high-frequency 3 dB axial ratio bandwidth is widened to 6.69-7.22 GHz. In the presence of the artificial reflecting surface, the axial ratio beamwidth of the circularly polarized antenna is greatly widened, as shown in FIG. 10, the low-frequency axial ratio beamwidth of the circularly polarized antenna is widened to an average of 110°, exceeding 100° within a stable range in the operating band; and the low-frequency axial ratio beamwidth of the circularly polarized antenna is increased to an average of 65°, exceeding 70° within the frequency range of 6.8-7.1 GHz. In addition, in the operating frequency band of the antenna, the gain remains stable above 5 dB, as shown in FIG. 11.

The above embodiments are merely preferred ones of the invention. It should be understood that the invention is not limited to the embodiments disclosed here, and the above embodiments should not be construed as excluding other embodiments. The invention may be applied to various other combinations, modifications, and environments, and transformations may be made based on the above enlightenments or techniques, or knowledge in the related art within the concept of the invention. All modifications and transformations made by those skilled in the art without departing from the spirit and scope of the invention should fall within the protection scope of the appended claims of the invention.

1. A dual-band circularly polarized antenna based on a thermal protection system, comprising: a thermal protection system (1) and an artificial reflecting surface (7), wherein the thermal protection system (1) is a planar double-layer thermal protection sheet and covers the dual-band circularly polarized antenna (2) to isolate the antenna from an external heat source, the artificial reflecting surface (7) is arranged at a bottom of an antenna substrate to replace a ground plate of the antenna, spaced apart from the antenna by a set distance and configured to repair degradation of circular polarization performance of the antenna caused by loading of the thermal protection system and the ground plate;
the artificial reflecting surface is obtained by:
calculating an equivalent network for widening an axial ratio beamwidth of an ideal circularly polarized antenna, wherein the equivalent network is formed by lossless LC elements and transmission lines; designing corresponding artificial reflecting surface unit structures according to the obtained equivalent network, wherein the LC elements are fitted by surface metallic patches, and the transmission lines are fitted by a dielectric substrate; and
periodically arranging the artificial reflecting surface unit structures to obtain the artificial reflecting surface;
an outer layer of the double-layer thermal protection sheet is a surface ablating layer and has a dielectric constant of 2-9, and an inner layer of the double-layer thermal protection sheet is a heat insulation layer and has a dielectric constant of 1.2-9;
the outer layer of the double-layer thermal protection sheet has a thickness of 8-12 mm, and the inner layer of the double-layer thermal protection sheet has a thickness of 6-15 mm;
the dual-band circularly polarized antenna is a printed antenna with a profile less than a set value;
the outer layer (5) of the double-layer thermal protection sheet is made from a fiber-enhanced silica composite material and has a dielectric constant of 3.2, and the inner layer (6) of the double-layer thermal protection sheet is made from a fiber-enhanced silica aerogel composite material and has a dielectric constant of 1.2;
the artificial reflecting surface (7) is formed by the dielectric substrate (3) and the surface metallic patches (4); and
the dielectric substrate (3) is made from a material with a dielectric constant of 1.2-9 and has a thickness of 0.25-2 mm.

2. A design method for an artificial reflecting surface, applied to the dual-band circularly polarized antenna based on the thermal protection system according to claim 1, wherein the design method comprises:
S1, calculating the equivalent network for widening the axial ratio beamwidth of the ideal circularly polarized antenna, wherein the equivalent network is formed by the lossless LC elements and the transmission lines;
S2, designing the corresponding artificial reflecting surface unit structures according to the obtained equivalent network, wherein the LC elements are fitted by the surface metallic patches, and the transmission lines are fitted by the dielectric substrate; and
S3, periodically arranging the artificial reflecting surface unit structures to obtain the artificial reflecting surface.
